(19) United States
(12) Patent Application Publication
(10) Pub. No.: US 2025/0054474 A1
(43) Pub. Date: Feb. 13, 2025

(54) METHOD, APPARATUS, ELECTRONIC DEVICE AND STORAGE MEDIUM FOR AUDIO PROCESSING

(71) Applicants: Beijing Zitiao Network Technology Co., Ltd., Beijing (CN); Lemon Inc., Grand Cayman (KY)

(72) Inventors: Junyu DAI, Beijing (CN); Bing HAN, Beijing (CN); Xuchen SONG, Los Angeles, CA (US); Weituo HAO, Los Angeles, CA (US); Xinyan HE, Beijing (CN); Dong GUO, CULVER CITY, CA (US)

(21) Appl. No.: 18/797,491

(22) Filed: Aug. 7, 2024

(30) Foreign Application Priority Data
Aug. 8, 2023 (CN) 202310993452.3

(51) Int. Cl. G10H 1/00; G06F 40/30

(52) U.S. Cl. CPC G10H 1/0025; G06F 40/30; G10H 2210/036; G10H 2210/056; G10H 2210/111; G10H 2210/576; G10H 2250/311

(57) ABSTRACT

Embodiments of the present disclosure provide an audio processing method and apparatus, an electronic device and a storage medium, wherein the method comprises: obtaining first music data and a processing instruction in text form associated with the first music data; extracting, by a music processing model, a first chord progression feature and an audio feature of the first music data, and a text feature of the processing instruction; processing, by the music processing model, the audio feature in accordance with the first chord progression feature and the text feature, to generate second music data; wherein a similarity between a first chord progression feature of the first music data and a second chord progression feature of the second music data is greater than a similarity threshold.

### CROSS-REFERENCE TO RELATED APPLICATION(S)

This application claims priority to Chinese Application No. 202310993452.3 filed Aug. 8, 2023, the disclosure of which is incorporated herein by reference in its entity.

### FIELD

The present disclosure relates to the field of computer technologies, and more specifically, to a method, apparatus, an electronic device and a storage medium for audio processing.

### BACKGROUND

Existing technologies can process the audio data, e.g., adding meow of kittens into a piece of audio data of bird chirping. However, the schemes in the existing technologies focus on speech processing, rather than music processing. After the music is processed by the existing technologies, the music before and after processing are less harmonious and consistent in musicality

### SUMMARY

Embodiments of the present disclosure provide a method, apparatus, an electronic device and a storage medium for audio processing. The embodiments may process the music data and ensure that the music data before and after processing are highly harmonious and consistent in musicality.

In a first aspect, embodiments of the present disclosure provide a method for audio processing, comprising:
obtaining first music data and a processing instruction in text form associated with the first music data;
extracting, by a music processing model, a first chord progression feature and an audio feature of the first music data, and a text feature of the processing instruction; and
processing, by the music processing model, the audio feature in accordance with the first chord progression feature and the text feature, to generate second music data; wherein a similarity between a first chord progression feature of the first music data and a second chord progression feature of the second music data is greater than a similarity threshold.

In a second aspect, embodiments of the present disclosure provide an apparatus for audio processing, comprising:
an obtaining unit configured to obtain first music data and a processing instruction in text form associated with the first music data;
an extracting unit configured to extract, by a music processing model, a first chord progression feature and an audio feature of the first music data, and a text feature of the processing instruction;
a generating unit configured to process, by the music processing model, the audio feature in accordance with the first chord progression feature and the text feature, to generate second music data; wherein a similarity between a first chord progression feature of the first music data and a second chord progression feature of the second music data is greater than a similarity threshold.

In a third aspect, embodiments of the present disclosure provide an electronic device, comprising: a processor; and a memory configured to store computer-executable instructions, the computer-executable instructions, when executed, causing the processor to implement steps of the method according to the above first aspect.

In a fourth aspect, embodiments of the present disclosure provide a computer readable storage medium, wherein the computer readable stored medium stores computer-executable instructions, the computer-executable instructions, when executed by a processor, implementing steps of the method according to the above first aspect.

In one or more embodiments of the present disclosure, first music data and a processing instruction in text form associated with the first music data are obtained; a first chord progression feature and an audio feature of the first music data and a text feature of the processing instruction are extracted by a music processing model; the audio feature is processed, by the music processing model, in accordance with the first chord progression feature and the text feature, to generate second music data; wherein a similarity between a first chord progression feature of the first music data and a second chord progression feature of the second music data is greater than a similarity threshold. Accordingly, since the music processing model may extract the first chord progression feature of the first music data and generate the second music data based on the extracted first chord progression feature, the music processing model, when processing the first music data to generate the second music data, may ensure that the chord progression features of the first music data and the second music data are quite consistent. Therefore, the first music data and the second music data are highly harmonious and consistent in musicality.

### BRIEF DESCRIPTION OF THE DRAWINGS

Brief introduction of the drawings required in the description of the specific embodiments or the prior art are to be provided below to more clearly explain one or more embodiments of the present disclosure or the technical solutions in the prior art. It is obvious that the following drawings illustrate some embodiments of the present disclosure and those skilled in the art also may obtain other drawings on the basis of those illustrated ones without any exercises of inventive work.

FIG. 1 illustrates a schematic flowchart of the audio processing method provided by one embodiment of the present disclosure;

FIG. 2 illustrates a schematic diagram of application principles of a music processing model provided by one embodiment of the present disclosure;

FIG. 3 illustrates a schematic flow of training the music processing model provided by one embodiment of the present disclosure;

FIG. 4 illustrates a schematic diagram of training principles for the music processing model provided by one embodiment of the present disclosure;

FIG. 5 illustrates a structural diagram of the audio processing apparatus provided by one embodiment of the present disclosure; and

FIG. 6 illustrates a structural diagram of the electronic device provided by one embodiment of the present disclosure.

### DETAILED DESCRIPTION OF EMBODIMENTS

To allow those skilled in the art to better understand the technical solutions in one or more embodiments of the present disclosure, the technical solutions in one or more embodiments of the present disclosure are to be described clearly and comprehensively below with reference to the drawings in one or more embodiments of the present disclosure. Apparently, the described embodiments are only part of the embodiments of the present disclosure, rather than all of them. Based on one or more embodiments of the present disclosure, all other embodiments obtained by those skilled in the art without requiring any exercises of inventive work should fall within the protection scope of the present disclosure.

Embodiments of the present disclosure provide an audio processing method, which may process music data and ensure that the music data before processing and the music data after processing are highly harmonious and consistent in musicality.

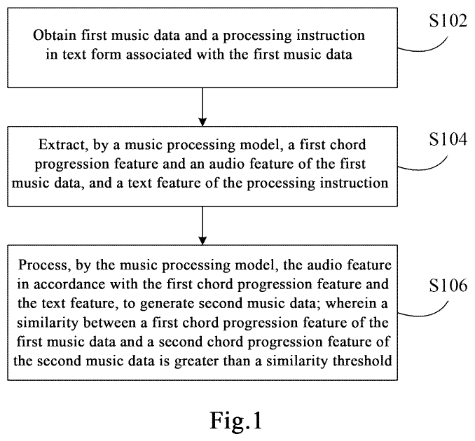

FIG. 1 is a schematic flow of an audio processing method provided by one embodiment of the present disclosure. As shown in FIG. 1, the flow comprises:
Step S102: obtaining first music data and a processing instruction in text form associated with the first music data;
Step S104: extracting, by a music processing model, a first chord progression feature and an audio feature of the first music data, and a text feature of the processing instruction;
Step S106: processing, by the music processing model, the audio feature in accordance with the first chord progression feature and the text feature, to generate second music data; wherein a similarity between a first chord progression feature of the first music data and a second chord progression feature of the second music data is greater than a similarity threshold.

In this embodiment, first music data and a processing instruction in text form associated with the first music data are obtained; a first chord progression feature and an audio feature of the first music data and a text feature of the processing instruction are extracted by a music processing model; the audio feature is processed, by the music processing model, in accordance with the first chord progression feature and the text feature, to generate second music data; wherein a similarity between a first chord progression feature of the first music data and a second chord progression feature of the second music data is greater than a similarity threshold. Accordingly, since the music processing model may extract the first chord progression feature of the first music data and generate the second music data based on the extracted first chord progression feature, the music processing model, when processing the first music data to generate the second music data, may ensure that the chord progression features of the first music data and the second music data are quite consistent. Therefore, the first music data and the second music data are highly harmonious and consistent in musicality.

The flow in FIG. 1 is to be explained in details below.

In the above step S102, the first music data and the processing instruction in text form associated with the first music data are obtained. The first music data is the music data before processing. The first music data and the processing instruction in text form associated with the first music data may be input by users. The users may process the first music data by inputting the first music data and the processing instruction. The processing instruction may enable at least one of the processing on the first music data: adding an instrument track to the first music data, deleting an existing instrument track in the first music data, modifying music style of the first music data, and modifying music emotion of the first music data, and the music style refers to the style of melody and for example may be fast-rhythm, slow-rhythm, radical, high-pitched, soothing and low-pitched etc.; and the music emotion describes the emotional feelings the music brings to audience and for example may be happy, cheerful, sad, depressed and peaceful etc.

A piece of pure music made by piano and bass is taken as the example of the first music data. In one example where the processing instruction is “adding guitar”, the processing instruction is used to remix the first music data by adding a guitar track. In another example where the processing instruction is “removing bass”, the processing instruction is used to remix the first music data by deleting the existing bass track in the first music data. In a further example where the processing instruction includes “adding guitar, removing bass and processing music into fast rhythm style”, the processing instruction is provided to remix the first music data by adding a guitar track, deleting the bass track and processing the first music data as music data with fast rhythm style. In another example where the processing instruction includes “adding guitar and processing the music into sad music”, the processing instruction is used to remix the first music data by adding a guitar track and processing the first music data as the music data which delivers sad emotions when heard by the audience.

In one example, the users may upload the first music data in a terminal device, such as mobile phone, and input the processing instruction in text form in a way similar to entering chat information to obtain the first music data and the processing instruction. In another example, the users may upload the first music data in a terminal device, such as mobile phone, and input the processing instruction in audio form in a way similar to inputting chat information to obtain the first music data and the processing instruction in audio form. Then, the processing instruction in audio form is converted into the processing instruction in text form. After the second music data is obtained, the terminal device may play the second music data to implement user-interactive music data processing.

In the above step S102, the first music data and the processing instruction in text form are also input to the music processing model. The music processing model is a pre-trained model, which may process the first music model in accordance with the processing instruction in text form, to obtain the second music data matching the processing instructions. The second music data may match a processing content indicated by the processing instruction. For example, the first music data are remixed according to the processing instruction in text form in the above example by adding a guitar track and processing the first music data into the second music data which deliver sad emotions when heard by the audience.

In the above step S104, the music processing model extracts the chord progression feature of the first music data as the first chord progression feature, and extracts the audio feature of the first music data and the text feature of the processing instruction.

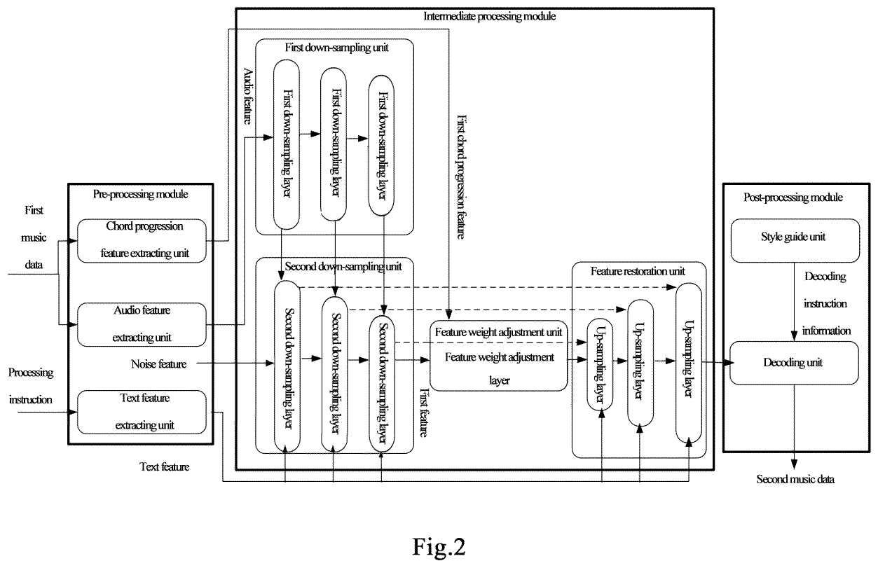

FIG. 2 is a schematic diagram of application principles of a music processing model provided by one embodiment of the present disclosure. As shown in FIG. 2, the music processing model includes a pre-processing module, the pre-processing module includes a chord progression feature extracting unit, an audio feature extracting unit and a text feature extracting unit. The first music data are input to the chord progression feature extracting unit and the audio feature extracting unit respectively. The first music data are processed by the chord progression feature extracting unit, to extract the chord progression feature of the first music data as the first chord progression feature. The first music data are processed by the audio feature extracting unit to extract the audio feature of the first music data. The first chord progression feature indicates chord type information of the first music data at different time points. The first chord progression feature may be denoted by a matrix, and the matrix implicitly represents the chord type information of the first music data at different time points. The audio feature indicates information of the first music data, including pitch information (high or low), music duration information, rhythm information and frequency information of audio. The audio feature may be denoted by a matrix, and the matrix implicitly represents information of the first music data, including pitch information (high or low), music duration information, rhythm information and frequency information of audio. The processing instruction is input to the text feature extracting unit, through which the processing instruction is processed to extract a text feature of the processing instruction. The text feature at least includes semantic information of the processing instruction.

In the above step S106, the audio feature is processed, by the music processing model, in accordance with the first chord progression feature and the text feature, to generate second music data. Since the second music data are generated with reference to the first chord progression feature of the first music data, a similarity between the first chord progression feature of the first music data and the second chord progression feature of the second music data is greater than a similarity threshold, to ensure consistent chord progression features between the first music data and the second music data. Accordingly, the first music data and the second music data are highly harmonious and consistent in musicality. The similarity threshold may be a preset threshold. The similarity between the first chord progression feature and the second chord progression feature is obtained by comparing the chord types at different time points represented by the first chord progression feature and the chord types at different time points denoted by the second chord progression feature. For example, the first chord progression feature represents the chord types at respective time points, respectively being type 1, type 2 and type 1; the second chord progression feature denotes the chord types at respective time points, each being type 1, type 2, type 4 and type 5. It is prescribed that the similarity equals to the number of same chord types (including repeated chord type) between the first chord progression feature and the second chord progression feature dividing a maximum value of the number of chord types of the first chord progression feature and the second chord progression feature (including repeated chord type). In such case, the similarity between the first chord progression feature and the second chord progression feature is determined to be 50%.

In one embodiment, processing, by the music processing model, the audio feature in accordance with the first chord progression feature and the text feature, to generate second music data includes:
performing, by the music processing model, feature compression processing on the audio feature and a noise feature of random noise data in accordance with the text feature to obtain a first feature; wherein the first feature is used to represent information associated with the processing instruction in the first music data and information associated with the processing instruction in the random noise data; the random noise data are noise data randomly generated for the first music data by the music processing model;
performing, by the music processing model, feature weight adjustment processing and feature restoration processing on the first feature in accordance with the first chord progression feature and the text feature, to generate second music data; wherein feature values in the first feature have feature weights, the feature weights indicating importance of the feature values at feature restoration; and the feature weight adjustment processing adjusts the feature weights.

In this embodiment, the music processing model may randomly generate noise data for the first music data, and the randomly generated noise data are random noise data. The audio feature extracting unit in the music processing model also may process the random noise data to extract noise features of the random noise data. Next, feature compression processing is performed, by the music processing model, on the audio feature and the noise feature in accordance with the text feature to obtain a first feature corresponding to the first music data and the random noise data. The first feature corresponding to the first music data and the random noise data may be data in matrix form and is a more abstract and more aggregated effective feature extracted from the audio feature of the first music data and the noise feature of the random noise data. The first feature corresponding to the first music data and the random noise data represents information associated with the user-input processing instruction in the first music data and information associated with the user-input processing instruction in the random noise data. The associated information is the effective information of the first music data and the random noise data.

Next, feature weight adjustment processing and feature restoration processing are performed, by the music processing model, on the first feature corresponding to the first music data and the random noise data in accordance with the above first chord progression feature and the above text feature, to generate second music data; wherein feature values in the first feature have feature weights, the feature weights indicating importance of the feature values at feature restoration; and the feature weight adjustment processing adjusts the feature weights of feature values in the first feature.

Accordingly, this embodiment generates, by the music processing model, random noise data for the first music data, extracts the first feature corresponding to the first music data and the random noise data in accordance with the text feature of the processing instruction and performs feature weight adjustment processing and feature restoration processing on the first feature in accordance with the first chord progression feature of the first music data and the text feature of the processing instruction to generate the second music data. As the second music data are obtained from performing the feature weight adjustment processing and the feature restoration processing on the first feature based on the first chord progression feature and the text feature, the similarity between the first chord progression feature of the first music data and the second chord progression feature of the second music data is greater than the similarity threshold, so as to ensure consistency between the chord progression features of the first music data and the second music data. Therefore, the second music data match with the processing content indicated by the processing instruction of the users, to generate music data meeting the users' requirements.

In one embodiment, performing, by the music processing model, feature compression processing on the audio feature and a noise feature of random noise data in accordance with the text feature to obtain a first feature includes:

down-sampling the audio feature by the music processing model, and down-sampling the noise feature and the down-sampled audio feature in accordance with the text feature to obtain the first feature.

In this embodiment, the audio feature of the first music data is down-sampled by the music processing model in the first place. Then, the noise feature of the random noise data and the down-sampled audio feature are down-sampled again in accordance with the text feature, to obtain the first feature.

Accordingly, in this embodiment, the audio feature of the first music data is down-sampled multiple times, such that the music processing model, when generating the first feature, learns the audio feature of the first music data more intensively. Therefore, the information associated with the processing instruction in the first music data denoted by the first feature is more accurate and the second music data generated based on the first feature are more aligned with users' requirements.

According to FIG. 2, in one embodiment, the music processing model includes an intermediate processing module. The intermediate processing module includes a first down-sampling unit and a second down-sampling unit; the first down-sampling unit includes a plurality of first down-sampling layers connected sequentially; and the second down-sampling unit includes a plurality of second down-sampling layers connected sequentially; on this basis, down-sampling the audio feature by the music processing model, and down-sampling the noise feature and the down-sampled audio feature in accordance with the text feature to obtain the first feature includes:

down-sampling the audio feature by respective first down-sampling layers; wherein an input of a first layer of first down-sampling layers includes the audio feature; an input of an n+1-th layer of first down-sampling layers includes an output of an n-th layer of first down-sampling layers; the n is greater than or equal to 1, and is smaller than or equal to an integer of T−1, and T is the number of first down-sampling layers;
down-sampling, by respective second down-sampling layers, the noise feature and the down-sampled audio feature in accordance with the text feature; wherein an input of a first layer of second down-sampling layers includes the noise feature, an output of a first layer of first down-sampling layers and the text feature; an input of an m+1-th layer of second down-sampling layers includes an output of an m-th layer of first down-sampling layers, an output of an n+1-th layer of first down-sampling layers and the text feature; the m is greater than or equal to 1, and is smaller than or equal to an integer of S−1, and S is the number of second down-sampling layers; a feature output by a last layer of second down-sampling layers is the first feature.

Referring to FIG. 2, in this embodiment, the music processing model includes an intermediate processing module. The intermediate processing module includes a first down-sampling unit and a second down-sampling unit, wherein the first down-sampling unit includes a plurality of first down-sampling layers connected sequentially. The drawing depicts three first down-sampling layers as the example for illustration. For a first layer of the first down-sampling layers, the audio feature of the first music data is the input. For each of the first down-sampling layers following the first layer of the first down-sampling layers, the output of the previous layer of the first down-sampling layers is the input. Each layer of the first down-sampling layers down-samples the input feature.

As shown in FIG. 2, in this embodiment, the second down-sampling unit includes a plurality of second down-sampling layers connected sequentially. The drawing depicts three second down-sampling layers as the example for illustration. For a first layer of the second down-sampling layers, the input includes the text feature of the processing instruction, the noise feature of the random noise data and the output of the first layer of the first down-sampling layers. For each of the second down-sampling layers following the first layer of the second down-sampling layers, the input includes the text feature of the processing instruction, the output of the previous layer of the second down-sampling layers and the output of first down-sampling layer at the same layer. For instance, for the second layer of the second down-sampling layers, the input includes the text feature of the processing instruction, the output of the first layer of the second down-sampling layers and the output of the second layer of the first down-sampling layers. Each layer of the second down-sampling layers down-samples the input feature.

It can be seen from FIG. 2 that the number of first down-sampling layers is identical to the number of second down-sampling layers. For the last layer of the second down-sampling layers, the input includes the text feature of the processing instruction, the output of the previous layer of the second down-sampling layers and the output of the last layer of the first down-sampling layers. The feature output by the last layer of the second down-sampling layers is the above first feature.

Therefore, in this embodiment, the audio feature is first down-sampled by the first down-sampling layers. Then, the noise feature of the random noise data and the down-sampled audio feature are then down-sampled again by the second down-sampling layers in accordance with the text feature, such that the music processing model, when generating the first feature, learns the audio feature of the first music data more intensively. Therefore, the information associated with the processing instruction in the first music data denoted by the first feature is more accurate.

Down-sampling mentioned in each embodiment of the present disclosure is an approach for feature compression. In actual implementation, the down-sampling also may be replaced by other feature compression means. The other feature compression means are not restricted here.

As illustrated in FIG. 2, in one embodiment, the intermediate processing module of the music processing module also comprises a feature weight adjustment unit and a feature restoration unit; on this basis, performing, by the music processing model, feature weight adjustment processing and feature restoration processing on the first feature in accordance with the first chord progression feature and the text feature, to generate second music data includes:
adjusting, by the feature weight adjustment unit, feature weights of respective feature values in the first feature in accordance with the first chord progression feature, to obtain the first feature after feature weight adjustment;
performing, by the feature restoration unit, feature restoration on the first feature after feature weight adjustment in accordance with the text feature, to generate second music data.

According to FIG. 2, in this embodiment, the intermediate processing module of the music processing module also comprises a feature weight adjustment unit and a feature restoration unit. The input of the feature weight adjustment unit includes the first chord progression feature and the first feature of the first music data. The feature weight of each feature value in the first feature is adjusted by the feature weight adjustment unit in accordance with the first chord progression feature, to obtain the first feature after feature weight adjustment, wherein the feature value in the first feature represents the information associated with the processing instruction in the first music data and the information associated with the processing instruction in the random noise data. Each feature value has its own feature weight, which feature weight may denote importance of the feature value at feature restoration. When the feature weight of each feature value is adjusted, it means adjusting importance of each feature value at subsequent feature restoration, so as to perform feature restoration based on the first feature after feature weight adjustment, to obtain the second music data matching the processing instruction and having the second chord progression feature meeting the requirements.

Moreover, as shown in FIG. 2, the first feature after feature weight adjustment is also input to the feature restoration unit. The feature restoration is performed on the first feature after feature weight adjustment by the feature restoration unit in accordance with the text feature, to generate the second music data.

Therefore, by this embodiment, feature weights of respective feature values in the first feature are first adjusted, by the feature weight adjustment unit, in accordance with the first chord progression feature, to obtain the first feature after feature weight adjustment; next, feature restoration is performed, by the feature restoration unit, on the first feature after feature weight adjustment in accordance with the text feature, to generate second music data. By adjusting the feature weights of the feature values of the first feature, the second music data matching the processing instruction and having the second chord progression feature meeting the requirements may be obtained from the feature restoration based on the first feature after feature weight adjustment, which enhances the accuracy for generating the second music data.

According to FIG. 2, the feature weight adjustment unit includes a feature weight adjustment layer based on attention mechanism; on this basis, adjusting, by the feature weight adjustment unit, feature weights of respective feature values in the first feature in accordance with the first chord progression feature, to obtain the first feature after feature weight adjustment includes:
adjusting, by the feature weight adjustment layer, feature weights of respective feature values in the first feature based on attention mechanism in accordance with the first chord progress feature, to obtain the first feature after feature weight adjustment.

In this embodiment, in accordance with the first chord progression feature, the feature weights of respective feature values in the first feature may be adjusted based on cross attention mechanism by the feature weight adjustment layer, to obtain the first feature after feature weight adjustment.

It is to be noted that in the model shown by FIG. 2, the first down-sampling layers, the second down-sampling layers, the feature weight adjustment layer in the feature weight adjustment unit and the up-sampling layers in the feature restoration unit all follow the cross attention mechanism-based processing policy. The difference is that the second down-sampling layers and the up-sampling layers in the feature restoration unit may only adopt the cross attention mechanism in accordance with the text feature of the processing instruction to process the features. In the feature weight adjustment layer, the cross attention mechanism may be utilized in accordance with the first chord progression feature to process the features, such that the similarity between the second chord progression feature of the generated second music data and the first chord progression feature of the first music data is greater than the similarity threshold.

Accordingly, by this embodiment, the feature weights of respective feature values in the first feature may be efficiently and rapidly adjusted based on the attention mechanism by the feature weight adjustment layer in accordance with the first chord progression feature, to improve the efficiency for obtaining the first feature after feature weight adjustment.

As demonstrated in FIG. 2, the feature restoration unit includes a plurality of up-sampling layers connected sequentially; performing, by the feature restoration unit, feature restoration on the first feature after feature weight adjustment in accordance with the text feature, to generate second music data includes:
up-sampling, by respective up-sampling layers, the first feature after feature weight adjustment in accordance with the text feature; wherein an input of a first layer of up-sampling layers includes the first feature after feature weight adjustment and the text feature; an input of a p+1-th layer of up-sampling layers includes an output of a p-th layer of up-sampling layers and the text feature; the p is greater than or equal to 1, and is smaller than or equal to an integer of W−1, wherein the W is the number of up-sampling layers;
decoding a feature output by a last layer of up-sampling layers to obtain second music data.

Referring to FIG. 2, the feature restoration unit includes a plurality of up-sampling layers connected in sequence and the drawing depicts three up-sampling layers as the example for illustration. For the first layer of the up-sampling layers, the input includes the text feature of the processing instruction and the first feature; for each of the up-sampling layers following the first layer of the up-sampling layers, the input includes the output of the previous layer of the up-sampling layers and the text feature. As shown in FIG. 2, the second down-sampling layer and the up-sampling layer are provided in the same quantity. The second down-sampling layer is in residual connection with the up-sampling layers, and the output of each of the second down-sampling layers also serves as the input for a corresponding up-sampling layer. Each up-sampling layer up-samples the input features.

In this embodiment, the feature output by the last layer of the up-sampling layers is also decoded to obtain the second music data.

Therefore, in this embodiment, the first feature after feature weight adjustment is up-sampled by respective up-sampling layers in accordance with the text feature; and a feature output by a last layer of up-sampling layers is decoded to obtain second music data. Since the first feature after feature weight adjustment is up-sampled in accordance with the text feature of the processing instruction, the generated second music data may match the processing instruction of the users.

According to FIG. 2, in one embodiment, the music processing model also includes a post-processing module. The post-processing module includes an emotion style guide unit and a decoding unit; on this basis, decoding a feature output by a last layer of up-sampling layers to obtain second music data includes:
identifying, by the emotion style guide module, a music emotion and/or music style indicated by the text feature as decoding instruction information;
instructing, by the emotion style guide module, the decoding unit to decode a feature output by a last layer of up-sampling layers in accordance with the decoding instruction information, to obtain second music data matching the decoding instruction information.

In this embodiment, the text feature of the processing instruction is also input to the emotion style guide module, which emotion style guide module identifies the music emotion indicated by the text feature as decoding instruction information, or identifies the music style indicated by the text feature as decoding instruction information, or identifies the music emotion and the music style indicated by the text feature as decoding instruction information.

Further, the emotion style guide module instructs the decoding unit to decode a feature output by a last layer of up-sampling layers in accordance with the decoding instruction information, to obtain second music data matching the decoding instruction information. The emotion style guide module may calculate a gap between the decoding instruction information and the decoded second music data and adjust the audio feature and the first chord progression feature of the first music data based on the gap feedback instruction, to adjust the first feature and generate the adjusted second music data. Thus, the second music data matching the decoding instruction information are finally generated.

Accordingly, in this embodiment, since the music emotion and/or music style indicated by the text feature may be identified as the decoding instruction information, and the feature output by the last layer of the up-sampling layers may be decoded according to the decoding instruction information to obtain the second music data, the second music data may match the decoding instruction information and have the music style and/or music emotion desired by the users.

In a specific example, in the pre-processing module of the music processing module, the audio feature extracting unit includes an auto encoder, which may take the input information as learning objective and conduct representative learning on the input information; or the audio feature extracting unit may be implemented by an audio feature extraction network of SoundStream model. The chord progression feature extracting unit may be implemented by existing technologies, such as those disclosed in Article-“JOINTIST: JOINT LEARNING FOR MULTI-INSTRUMENT TRANSCRIPTION AND ITS APPLICATIONS”.

In one specific example, the intermediate processing module of the music processing module may be implemented based on unet network of Diffusion Model.

In one specific example, in the post-processing module of the music processing module, the decoding unit may be implemented based on the auto decoder, or a decoding network of SoundStream model. The emotion style guide unit may be implemented on the basis of Mulan model, CLAP model and the like.

In a specific example, in case that the intermediate processing module of the music processing module is implemented based on unet network of Diffusion Model, Chunk Transformer may replace Spatial Transformer in the unet network. In FIG. 2, the first down-sampling layers, the second down-sampling layers, the feature weight adjustment layer and the up-sampling layers all may be Chunk Transformer. The Chunk Transformer may segment the input features into feature fragments of fixed length and perform feature processing based on the feature fragments, so as to lift the restrictions over the length of the input feature. Thus, the music processing module may process the first music data of any length and may ensure that the length of the second music data is the same as the length of the first music data.

With reference to FIG. 2, the first down-sampling layers may segment the audio feature into feature fragments of fixed length and process the features based on the feature fragments; the second down-sampling layers may segment the noise feature into feature fragments of fixed length and process the features based on the feature fragments; the feature weight adjustment layer may segment the first feature into feature fragments of fixed length and process the features based on the feature fragments; the up-sampling layers may segment the first feature processed into feature fragments of fixed length and process the features based on the feature fragments.

The detailed procedure of processing the first music data based on the music processing model has been introduced above. Next, a training procedure of the music processing model is described below.

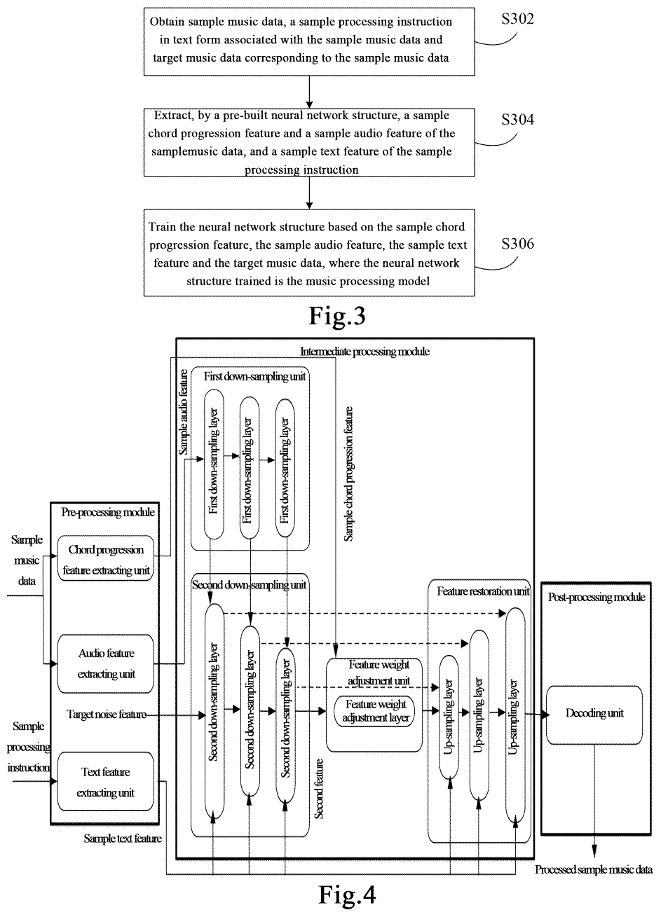

FIG. 3 is a schematic flow of training the music processing model provided by one embodiment of the present disclosure. As shown in FIG. 3, the flow comprises:

Step S302: obtaining sample music data, a sample processing instruction in text form associated with the sample music data and target music data corresponding to the sample music data;

Step S304: extracting, by a pre-built neural network structure, a sample chord progression feature and a sample audio feature of the sample music data, and a sample text feature of the sample processing instruction;

Step S306: training the neural network structure based on the sample chord progression feature, the sample audio feature, the sample text feature and the target music data, where the trained neural network structure is the music processing model

In the above step S302 of FIG. 3, sample music data, a sample processing instruction in text form associated with the sample music data and target music data corresponding to the sample music data are obtained. The target music data are music data expected to be obtained from processing the sample music data. The sample music data, the sample processing instruction in text form associated with the sample music data and the target music data may be obtained in the form of artificial construction.

In the above step S304, a sample chord progression feature and a sample audio feature of the sample music data, and a sample text feature of the sample processing instruction are extracted by a pre-built neural network structure. FIG. 4 is a schematic diagram of training principles for the music processing model provided by one embodiment of the present disclosure. As shown in FIG. 4, since the emotion style guide unit may be pre-trained, it is no longer required to train the emotion style guide unit during the training of the music processing model. In comparison to FIG. 2, there is no emotion style guide unit in FIG. 4.

Referring to FIG. 4, which is a similar procedure to FIG. 2, the sample audio feature of the sample music data may be extracted by the audio feature extracting unit to be trained; the sample chord progression feature of the sample music data may be extracted by the chord progression feature extracting unit to be trained; and the sample text feature of the sample processing instruction may be extracted by the text feature extracting unit to be trained. The sample chord progression feature represents the chord type information of the sample music data at different time points; and the sample audio feature indicates information of the sample music data, including pitch information (high or low), music duration information, rhythm information and frequency information of audio. The sample text feature at least includes semantic information of the sample processing instruction.

In the above step S306, the neural network structure is trained based on the sample chord progression feature, the sample audio feature, the sample text feature and the target music data, where the trained neural network structure is the music processing model.

Therefore, by this embodiment, the music processing model may be efficiently and rapidly trained in accordance with the sample music data, the sample processing instruction in text form associated with the sample music data and the target music data corresponding to the sample music data. Since the sample chord progression feature of the sample music data is used during the training of the music processing model, the music processing model performs well in maintaining consistency of the chord progression feature, such that the music data before processing and after processing are highly harmonious and consistent in musicality.

In one embodiment, training the neural network structure based on the sample chord progression feature, the sample audio feature, the sample text feature and the target music data includes:
superimposing, by the neural network structure, sample random noise data on the target music data to obtain target noise data;
extracting, by the neural network structure, a target noise feature of the target noise data;
training the neural network structure based on the sample chord progression feature, the sample audio feature, the sample text feature and the target noise feature.

As shown in FIG. 4, the music processing model in training may randomly generate noise data for the sample music data. The randomly generated noise data are the sample random noise data. The audio feature extracting unit in the music processing model also may superimpose the target music data and the sample random noise data to obtain the target noise data and extract the target noise feature of the target noise data. Next, the neural network structure is trained based on the sample chord progression feature, the sample audio feature, the sample text feature and the target noise feature.

Therefore, by this embodiment, the sample random noise data can be superimposed on the target music data to obtain the target noise data; the target noise feature of the target noise data is extracted and the neural network structure is trained efficiently and rapidly based on the sample chord progression feature, the sample audio feature, the sample text feature and the target noise feature.

In one example, training the neural network structure based on the sample chord progression feature, the sample audio feature, the sample text feature and the target noise feature includes:
performing, by the neural network structure, feature compression processing on the sample audio feature and the target noise feature in accordance with the sample text feature to obtain a second feature; wherein the second feature represents information associated with the sample processing instruction in the sample music data and information associated with the sample processing instruction in the target noise data;
performing, by the neural network structure, feature weight adjustment processing and feature restoration processing on the second feature in accordance with the sample chord progression feature and the sample text feature, to generate processed sample data music; wherein feature values in the second feature have feature weights, and the feature weights indicate importance of the feature values at feature restoration; and the feature weight adjustment processing adjusts the feature weights;
training the neural network structure based on the processed sample music data and the target music data.

In this embodiment, feature compression processing is performed, by the music processing model in training, i.e., neural network structure, on the sample audio feature and the target noise feature in accordance with the sample text feature to obtain a second feature. Similar to the first feature, the second feature may be data in matrix form and is a more abstract and more aggregated effective feature extracted from the sample audio feature of the sample music data and the target noise feature of the target noise data. The second feature represents information associated with the sample processing instruction in the sample music data and information associated with the sample processing instruction in the target noise data. The associated information is the effective information of the sample music data and the target noise data.

Next, feature weight adjustment processing and feature restoration processing are performed, by the neural network structure, on the second feature in accordance with the sample chord progression feature and the sample text feature, to generate processed sample data music; and feature values in the second feature have feature weights, the feature weights indicates importance of the feature values at feature restoration; and the feature weight adjustment processing adjusts the feature weights. The neural network structure is trained based on the processed sample music data and the target music data.

Accordingly, by this embodiment, the feature weight adjustment processing and the feature restoration processing are performed on the second feature in accordance with the sample chord progression feature and the sample text feature to generate processed sample music data; and the neural network structure is trained based on the processed sample music data and the target music data. Therefore, when the well-trained model is processing the music data, the similarity between the chord progression features of the music data before and after processing is greater than the similarity threshold, to generate music data meeting the users' needs.

In one embodiment, performing, by the neural network structure, feature compression processing on the sample audio feature and the target noise feature in accordance with the sample text feature to obtain a second feature includes:
down-sampling, by the neural network structure, the sample audio feature, and down-sampling the target noise feature and the down-sampled sample audio feature in accordance with the sample text feature, to obtain the second feature.

In this embodiment, the neural network structure first down-samples the sample audio feature of the sample music data and then down-samples the target noise feature of the target noise data and the down-sampled sample audio feature again in accordance with the sample text feature to obtain the second feature.

Accordingly, in this embodiment, the sample audio feature of the sample music data is down-sampled multiple times, such that the music processing model, when being trained, learns the sample audio feature of the sample music data more intensively. Therefore, the information associated with the sample processing instruction in the sample music data denoted by the second feature is more accurate and the trained music processing model may generate the music data more aligned with users' requirements.

As shown in FIG. 4, the pre-built neural network structure includes an intermediate processing module. The intermediate processing module includes a first down-sampling unit and a second down-sampling unit; the first down-sampling unit consists of a plurality of first down-sampling layers connected sequentially; and the second down-sampling unit includes a plurality of second down-sampling layers connected sequentially; on this basis, the down-sampling the sample audio feature by the neural network structure, and down-sampling the target noise feature and the down-sampled sample audio feature in accordance with the sample text feature to obtain the second feature includes:
down-sampling the sample audio feature by respective first down-sampling layers; wherein an input of a first layer of first down-sampling layers includes the sample audio feature; an input of an n+1-th layer of first down-sampling layers includes an output of an n-th layer of first down-sampling layers; the n is greater than or equal to 1, and is smaller than or equal to an integer of T−1, and the T is the number of first down-sampling layers;
down-sampling, by respective second down-sampling layers, the target noise feature and the down-sampled sample audio feature in accordance with the sample text feature; wherein an input of a first layer of second down-sampling layers includes the target noise feature, an output of a first layer of first down-sampling layers and the sample text feature; an input of an m+1-th layer of second down-sampling layers includes an output of an m-th layer of first down-sampling layers, an output of an n+1-th layer of first down-sampling layers and the sample text feature; the m is greater than or equal to 1, and is smaller than or equal to an integer of S−1, and S is the number of second down-sampling layers; a feature output by a last layer of second down-sampling layers is the second feature.

Referring to FIG. 4, in this embodiment, the neural network includes an intermediate processing module. The intermediate processing module consists of a first down-sampling unit and a second down-sampling unit, wherein the first down-sampling unit includes a plurality of first down-sampling layers connected sequentially. The drawing depicts three first down-sampling layers as the example for illustration. For a first layer of the first down-sampling layers, the sample audio feature of the sample music data is the input. For each of the first down-sampling layers following the first layer of the first down-sampling layers, the output of the previous layer of the first down-sampling layers is the input. Each layer of the first down-sampling layers down-samples the input feature.

As shown in FIG. 4, in this embodiment, the second down-sampling unit includes a plurality of second down-sampling layers connected sequentially. The drawing depicts three second down-sampling layers as the example for illustration. For a first layer of the second down-sampling layers, the input includes the sample text feature of the sample processing instruction, the target noise feature of the target noise data and the output of the first layer of the first down-sampling layers. For each of the second down-sampling layers following the first layer of the second down-sampling layers, the input includes the sample text feature of the sample processing instruction, the output of the previous layer of the second down-sampling layers and the output of first down-sampling layer at the same layer. For instance, for the second layer of the second down-sampling layers, the input includes the sample text feature of the sample processing instruction, the output of the first layer of the second down-sampling layers and the output of the second layer of the first down-sampling layers. Each layer of the second down-sampling layers down-samples the input feature.

It can be seen from FIG. 4 that the number of first down-sampling layers is same to the number of second down-sampling layers. For the last layer of the second down-sampling layers, the input includes the sample text feature of the sample processing instruction, the output of the previous layer of the second down-sampling layers and the output of the last layer of the first down-sampling layers. The features output by the last layer of the second down-sampling layers is the second feature described above.

Therefore, in this embodiment, the sample audio feature is first down-sampled by the first down-sampling layers. Then, the target noise feature and the down-sampled sample audio feature are then down-sampled by the second down-sampling layers in accordance with the sample text feature, such that the neural network structure learns the audio feature of the first music data more intensively. Therefore, the information associated with the sample processing instruction in the sample music data denoted by the second feature is more accurate.

According to FIG. 4, in one embodiment, the intermediate processing module of the neural network structure also includes a feature weight adjustment unit and a feature restoration unit; on this basis, performing, by the neural network structure, feature weight adjustment processing and feature restoration processing on the second feature in accordance with the sample chord progression feature and the sample text feature, to generate processed sample data music includes:
adjusting, by the feature weight adjustment unit, feature weights of respective feature values in the second feature in accordance with the sample chord progression feature, to obtain the second feature after feature weight adjustment;
performing, by the feature restoration unit, feature restoration on the second feature after feature weight adjustment in accordance with the sample text feature, to generate processed sample music data.

Referring to FIG. 4, in this embodiment, the intermediate processing module of the neural network structure also includes a feature weight adjustment unit and a feature restoration unit. The input of the feature weight adjustment unit includes the sample chord progression feature and the second feature of the sample music data. The feature weight of each feature value in the second feature is adjusted by the feature weight adjustment unit in accordance with the sample chord progression feature, to obtain the second feature after feature weight adjustment, wherein the feature value in the second feature represents the information associated with the sample processing instruction in the sample music data and the information associated with the sample processing instruction in the target noise data. Each feature value has its own feature weight, which feature weight may denote importance of the feature value at feature restoration. When the feature weight of each feature value is adjusted, it means adjusting importance of each feature value at subsequent feature restoration, so as to perform feature restoration based on the second feature after feature weight adjustment, to obtain the processed sample music data.

Moreover, as shown in FIG. 4, the second feature after feature weight adjustment is also input to the feature restoration unit. The feature restoration is performed on the second feature after feature weight adjustment by the feature restoration unit in accordance with the sample text feature, to generate the processed sample music data.

Therefore, by this embodiment, feature weights of respective feature values in the second feature are first adjusted, by the feature weight adjustment unit, in accordance with the sample chord progression feature, to obtain the second feature after feature weight adjustment; next, feature restoration is performed, by the feature restoration unit, on the second feature after feature weight adjustment in accordance with the sample text feature, to generate processed sample music data. By adjusting the feature weight of the feature value of the second feature, the processed sample music data matching the sample processing instruction and having the chord progression feature meeting the requirements may be obtained after the feature restoration based on the second feature after feature weight adjustment, which enhances the accuracy for generating the processed sample music data and precision for model training.

According to FIG. 4, the feature weight adjustment unit includes a feature weight adjustment layer based on attention mechanism; on this basis, the adjusting, by the feature weight adjustment unit, feature weights of respective feature values in the second feature in accordance with the sample chord progression feature, to obtain the second feature after feature weight adjustment includes:
adjusting, by the feature weight adjustment layer, feature weights of respective feature values in the second feature based on attention mechanism in accordance with the sample chord progress feature, to obtain the second feature after feature weight adjustment.

In this embodiment, in accordance with the sample chord progression feature, the feature weights of respective feature values in the second feature may be adjusted based on cross attention mechanism by the feature weight adjustment layer, to obtain the second feature after feature weight adjustment.

It is to be noted that in the network structure shown by FIG. 4, the first down-sampling layers, the second down-sampling layers, the feature weight adjustment layer in the feature weight adjustment unit and the up-sampling layers in the feature restoration unit all follow the cross attention mechanism-based processing policy. The difference is that the second down-sampling layers and the up-sampling layers in the feature restoration unit can only adopt the cross attention mechanism in accordance with the sample text feature of the sample processing instruction to process the features. In the feature weight adjustment layer, the cross attention mechanism may be utilized in accordance with the sample chord progression feature to process the features, such that the similarity between the chord progression feature of the generated processed sample music data and the sample chord progression feature of the sample music data is greater than the similarity threshold. The accuracy for model training is therefore improved.

Accordingly, by this embodiment, the feature weights of respective feature values in the second feature may be efficiently and rapidly adjusted based on the attention mechanism by the feature weight adjustment layer in accordance with the sample chord progression feature, to improve the efficiency for obtaining the second feature after feature weight adjustment.

As demonstrated in FIG. 4, the feature restoration unit includes a plurality of up-sampling layers connected sequentially; on this basis, performing, by the feature restoration unit, feature restoration on the second feature after feature weight adjustment in accordance with the sample text feature, to obtain processed sample music data includes:
up-sampling, by respective up-sampling layers, the second feature after feature weight adjustment in accordance with the sample text feature; wherein an input of a first layer of up-sampling layers includes the second feature after feature weight adjustment and the sample text feature; an input of a p+1-th layer of up-sampling layers includes an output of a p-th layer of up-sampling layers and the sample text feature; the p is greater than or equal to 1, and is smaller than or equal to an integer of W−1, wherein W is the number of up-sampling layers;
decoding a feature output by a last layer of up-sampling layers to obtain processed sample music data.

Referring to FIG. 4, the feature restoration unit includes a plurality of up-sampling layers connected in sequence and the drawing depicts three up-sampling layers as the example for illustration. For the first layer of the up-sampling layers, the input includes the sample text feature of the sample processing instruction and the second feature; for each of the up-sampling layers following the first layer of the up-sampling layers, the input includes the output of the previous layer of the up-sampling layers and the sample text feature. As shown in FIG. 4, the second down-sampling layer and the up-sampling layer are provided in the same quantity. The second down-sampling layer is in residual connection with the up-sampling layers, and the output of each of the second down-sampling layers also serves as the input for a corresponding up-sampling layer. Each up-sampling layer up-samples the input feature.

In this embodiment, the feature output by the last layer of the up-sampling layers is also decoded to obtain the processed sample music data.

Therefore, in this embodiment, the second feature after feature weight adjustment is up-sampled, by respective up-sampling layers, in accordance with the sample text feature; and a feature output by a last layer of up-sampling layers is decoded to obtain processed sample music data. Since the second feature after feature weight adjustment is up-sampled in accordance with the sample text feature of the sample processing instruction, the generated processed sample music data may match the sample processing instruction.

In this embodiment, after the processed sample music data are obtained, the neural network structure may be trained based on differences between the processed sample music data and the target music data. Also, the sample random noise data added during the model training may be predicted in accordance with principles of the Diffusion Model, to train the model. The specific training approaches are not restricted here.

It is to be explained that the application procedure of the music processing model is similar to its training procedure. Therefore, the training procedure also may be explained with reference to the aforementioned application procedure.

In summary, the music data may be processed by the above music processing model, such that the chord progression features of the music data before and after processing are quite consistent, and the music data before and after processing are highly harmonious and consistent in musicality.

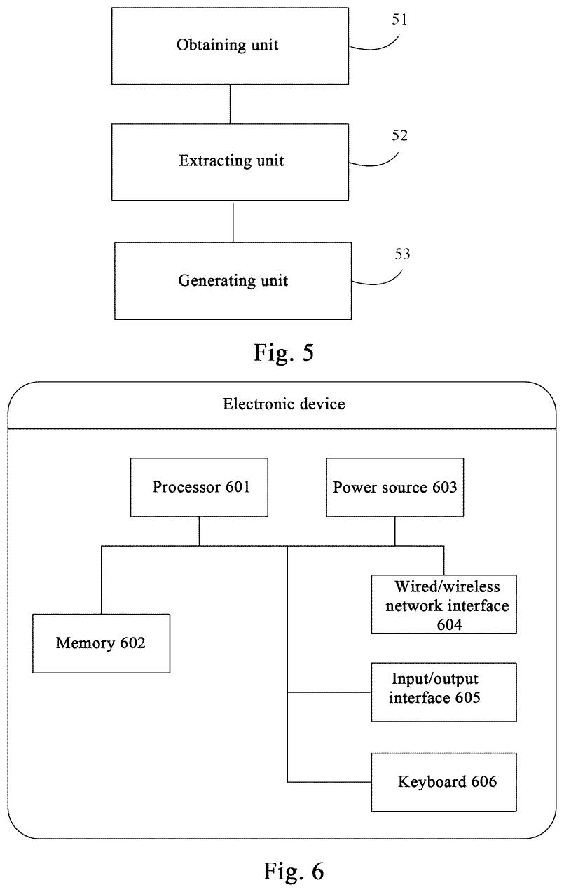

One embodiment of the present disclosure also provides an audio processing apparatus for implementing the above music processing method. FIG. 5 is a structural diagram of the audio processing apparatus provided by one embodiment of the present disclosure. As shown in FIG. 5, the apparatus comprises:
an obtaining unit 51, configured to obtain first music data and a processing instruction in text form associated with the first music data;
an extracting unit 52, configured to extract, by a music processing model, a first chord progression feature and an audio feature of the first music data, and a text feature of the processing instruction;
a generating unit 53, configured to process, by the music processing model, the audio feature in accordance with the first chord progression feature and the text feature, to generate second music data; wherein a similarity between a first chord progression feature of the first music data and a second chord progression feature of the second music data is greater than a similarity threshold.

Alternatively, the generating unit 53 is specifically configured to:
perform, by the music processing model, feature compression processing on the audio feature and a noise feature of random noise data in accordance with the text feature to obtain a first feature; wherein the first feature represents information associated with the processing instruction in the first music data and information associated with the processing instruction in the random noise data; the random noise data are noise data randomly generated for the first music data by the music processing model;
perform, by the music processing model, feature weight adjustment processing and feature restoration processing on the first feature in accordance with the first chord progression feature and the text feature, to generate second music data; wherein feature values in the first feature have feature weights, the feature weights indicating importance of the feature values at feature restoration; and the feature weight adjustment processing adjusts the feature weights.

Alternatively, the generating unit 53 is also specifically configured to:
down-sample the audio feature by the music processing model, and down-sampling the noise feature and the down-sampled audio feature in accordance with the text feature to obtain the first feature.

Alternatively, the music processing model includes a first down-sampling unit and a second down-sampling unit; the first down-sampling unit consists of a plurality of first down-sampling layers connected sequentially; and the second down-sampling unit consists of a plurality of second down-sampling layers connected sequentially; wherein the generating unit 53 is configured to:
down-sample the audio feature by respective first down-sampling layers; wherein an input of a first layer of first down-sampling layers includes the audio feature; an input of an n+1-th layer of first down-sampling layers includes an output of an n-th layer of first down-sampling layers; the n is greater than or equal to 1, and is smaller than or equal to an integer of T−1, where T is the number of first down-sampling layers;
down-sample, by respective second down-sampling layers, the noise feature and the down-sampled audio feature in accordance with the text feature; wherein an input of a first layer of second down-sampling layers includes the noise feature, an output of a first layer of first down-sampling layers and the text feature; an input of an m+1-th layer of second down-sampling layers includes an output of an m-th layer of first down-sampling layers, an output of an n+1-th layer of first down-sampling layers and the text feature; the m is greater than or equal to 1, and is smaller than or equal to an integer of S−1, wherein the S is the number of second down-sampling layers; a feature output by a last layer of second down-sampling layers is the first feature.

Alternatively, the music processing module includes a feature weight adjustment unit and a feature restoration unit; wherein the generating unit 53 is also configured to:
adjust, by the feature weight adjustment unit, feature weights of respective feature values in the first feature in accordance with the first chord progression feature, to obtain the first feature after feature weight adjustment;
perform, by the feature restoration unit, feature restoration on the first feature after feature weight adjustment in accordance with the text feature, to generate second music data.

Alternatively, the feature weight adjustment unit includes a feature weight adjustment layer based on attention mechanism; wherein the generating unit 53 is also specifically configured to:
adjust, by the feature weight adjustment layer, feature weights of respective feature values in the first feature based on attention mechanism in accordance with the first chord progress feature, to obtain the first feature after feature weight adjustment.

Alternatively, the feature restoration unit includes a plurality of up-sampling layers connected sequentially; wherein the generating unit 53 is specifically configured to:
up-sample, by respective up-sampling layers, the first feature after feature weight adjustment in accordance with the text feature; wherein an input of a first layer of up-sampling layers includes the first feature after feature weight adjustment and the text feature; an input of a p+1-th layer of up-sampling layers includes an output of a p-th layer of up-sampling layers and the text feature; the p is greater than or equal to 1, and is smaller than or equal to an integer of W−1, where W is the number of up-sampling layers;
decode a feature output by a last layer of up-sampling layers to obtain second music data.

Alternatively, the music processing model includes an emotion style guide unit and a decoding unit; wherein the generating unit 53 is specifically configured to:
identify, by the emotion style guide module, a music emotion and/or music style indicated by the text feature as decoding instruction information;
instruct, by the emotion style guide module, the decoding unit to decode a feature output by a last layer of up-sampling layers in accordance with the decoding instruction information, to obtain second music data matching the decoding instruction information.

Alternatively, there is included a model training unit configured to:
obtain sample music data, a sample processing instruction in text form associated with the sample music data and target music data corresponding to the sample music data;
extract, by a pre-built neural network structure, a sample chord progression feature and a sample audio feature of the sample music data, and a sample text feature of the sample processing instruction;
train the neural network structure based on the sample chord progression feature, the sample audio feature, the sample text feature and the target music data, where the trained neural network structure is the music processing model.

Alternatively, the model training unit is specifically configured to:
superimpose, by the neural network structure, sample random noise data on the target music data to obtain target noise data;
extract, by the neural network structure, a target noise feature of the target noise data;
train the neural network structure based on the sample chord progression feature, the sample audio feature, the sample text feature and the target noise feature.

Alternatively, the model training unit is specifically configured to:
perform, by the neural network structure, feature compression processing on the sample audio feature and the target noise feature in accordance with the sample text feature to obtain a second feature; wherein the second feature represents information associated with the sample processing instruction in the sample music data and information associated with the sample processing instruction in the target noise data;
perform, by the neural network structure, feature weight adjustment processing and feature restoration processing on the second feature in accordance with the sample chord progression feature and the sample text feature, to generate processed sample data music; wherein feature values in the second feature have feature weights, the feature weights indicating importance of the feature values at feature restoration; and the feature weight adjustment processing adjusts the feature weights;
train the neural network structure based on the processed sample music data and the target music data.

Alternatively, the model training unit is configured to:
down-sample, by the neural network structure, the sample audio feature, and down-sample the target noise feature and the down-sampled sample audio feature in accordance with the sample text feature, to obtain the second feature.

Alternatively, the neural network structure includes a first down-sampling unit and a second down-sampling unit; the first down-sampling unit consists of a plurality of first down-sampling layers connected sequentially; and the second down-sampling unit consists of a plurality of second down-sampling layers connected sequentially; wherein the model training unit is specifically configured to:
down-sample the sample audio feature by respective first down-sampling layers; wherein an input of a first layer of first down-sampling layers includes the sample audio feature; an input of an n+1-th layer of first down-sampling layers includes an output of an n-th layer of first down-sampling layers; the n is greater than or equal to 1, and is smaller than or equal to an integer of T−1, wherein T is the number of first down-sampling layers;
down-sample, by respective second down-sampling layers, the target noise feature and the down-sampled sample audio feature in accordance with the sample text feature; wherein an input of a first layer of second down-sampling layers includes the target noise feature, an output of a first layer of first down-sampling layers and the sample text feature; an input of an m+1-th layer of second down-sampling layers includes an output of an m-th layer of first down-sampling layers, an output of an n+1-th layer of first down-sampling layers and the sample text feature; the m is greater than or equal to 1, and is smaller than or equal to an integer of S−1, wherein S is the number of second down-sampling layers; a feature output by a last layer of second down-sampling layers is the second feature.

Alternatively, the neural network structure includes a feature weight adjustment unit and a feature restoration unit; wherein the model training unit is specifically configured to:
adjust, by the feature weight adjustment unit, feature weights of respective feature values in the second feature in accordance with the sample chord progression feature, to obtain the second feature after feature weight adjustment;
perform, by the feature restoration unit, feature restoration on the second feature after feature weight adjustment in accordance with the sample text feature, to generate processed sample music data.

Alternatively, the feature weight adjustment unit includes a feature weight adjustment layer based on attention mechanism; wherein the model training unit is specifically configured to:
adjust, by the feature weight adjustment layer, feature weights of respective feature values in the second feature based on attention mechanism in accordance with the sample chord progress feature, to obtain the second feature after feature weight adjustment.

Alternatively, the feature restoration unit includes a plurality of up-sampling layers connected sequentially; wherein the model training unit is also configured to:
up-sample, by respective up-sampling layers, the second feature after feature weight adjustment in accordance with the sample text feature; wherein an input of a first layer of up-sampling layers includes the second feature after feature weight adjustment and the sample text feature; an input of a p+1-th layer of up-sampling layers includes an output of a p-th layer of up-sampling layers and the sample text feature; the p is greater than or equal to 1, and is smaller than or equal to an integer of W−1, wherein the W is the number of up-sampling layers;
decode a feature output by a last layer of up-sampling layers to obtain processed sample music data.

The audio processing apparatus in the embodiment of the present disclosure may implement the respective procedure of the above audio processing method embodiment and achieve the same effects and functions, and thus will not be covered here.

One embodiment of the present disclosure also provides an electronic device. FIG. 6 illustrates a structural diagram of the electronic device provided by one embodiment of the present disclosure. As shown in FIG. 6, the electronic device may greatly differ due to configuration or performance variations, and may include one or more processors 601 and a memory 602, which memory 602 may store one or more applications or data. The memory 602 may be provided for transient storage or persistent storage. The applications stored in the memory 602 may include one or more modules (not shown), and each module may include a series of computer-executable instructions in the electronic device. Moreover, the processor 601 may be configured to communicate with the memory 602, to execute a series of computer-executable instructions stored in the memory 602 on the electronic device. The electronic device also may include one or more power sources 603, one or more wired or wireless network interfaces 604, one or more input or output interfaces 605 and one or more keyboards 606 etc.

In a specific embodiment, the electronic device includes a processor; and a memory configured to store computer-executable instructions, wherein the computer-executable instructions, when executed, cause the processor to fulfill the following procedure of:
obtaining first music data and a processing instruction in text form associated with the first music data;
extracting, by a music processing model, a first chord progression feature and an audio feature of the first music data, and a text feature of the processing instruction;
processing, by the music processing model, the audio feature in accordance with the first chord progression feature and the text feature, to generate second music data; wherein a similarity between a first chord progression feature of the first music data and a second chord progression feature of the second music data is greater than a similarity threshold.

The electronic device in the embodiments of the present disclosure may implement the respective procedure of the above audio processing method embodiment and achieve the same effects and functions, and thus will not be covered here.

A further embodiment of the present disclosure also proposes a computer-readable storage medium for storing computer-executable instructions, wherein the computer-executable instructions, when executed, cause the processor to fulfill the following procedure of:
obtaining first music data and a processing instruction in text form associated with the first music data;
extracting, by a music processing model, a first chord progression feature and an audio feature of the first music data, and a text feature of the processing instruction;
processing, by the music processing model, the audio feature in accordance with the first chord progression feature and the text feature, to generate second music data; wherein a similarity between a first chord progression feature of the first music data and a second chord progression feature of the second music data is greater than a similarity threshold.

The storage medium in the embodiment of the present disclosure may implement the respective procedure of the above audio processing method embodiment and achieve the same effects and functions, and thus will not be covered here.

In various embodiments of the present disclosure, the computer-readable storage medium includes Read-Only Memory (ROM), Random Access Memory (RAM), magnetic disc or optical disc etc.

In the 1990s, improvement of a technology can be clearly distinguished between hardware improvement (for example, improvement on a circuit structure such as a diode, a transistor, or a switch) and software improvement (improvement on a method procedure). However, with the development of technologies, improvement of many method procedures can be considered as direct improvement of a hardware circuit structure. Almost every designer programs an improved method procedure to a hardware circuit, to obtain a corresponding hardware circuit structure. Therefore, it cannot be concluded that improvement of a method procedure should not be implemented by using a hardware entity module. For example, a Programmable Logic Device (PLD) (for example, Field Programmable Gate Array (FPGA)) is such an integrated circuit, the logical function of which is determined by device programming executed by a user. The designers program by themselves to “integrate” a digital system into a single PLD without requiring a chip manufacturer to design and produce a dedicated integrated circuit chip. In addition, instead of manually fabricating an integrated circuit chip, the programming is mostly implemented by “logic compiler” software, which is similar to a software compiler used during program and development. Original codes before compiling are also written in a specific programming language, which is referred to as Hardware Description Language (HDL), and there is more than one type of HDL, such as ABEL (Advanced Boolean Expression Language), AHDL (Altera Hardware Description Language), Confluence, CUPL (Cornell University Programming Language), HDCal, JHDL (Java Hardware Description Language), Lava, a Lola, MyHDL, PALASM, and RHDL (Ruby Hardware Description Language), etc. Currently, VHDL (Very-High-Speed Integrated Circuit Hardware Description Language) and Verilog are the most commonly used. Those skilled in the art should also understand that a hardware circuit that implements the logical method procedure can be easily obtained just by logically programming the method procedure with the above several hardware description languages and then into the integrated circuit.

A controller can be implemented in any appropriate ways. For example, the controller may take the form of a microprocessor or a processor, or a computer-readable medium that stores computer readable program codes (such as software or firmware) that can be executed by the (micro) processor, a logic gate, a switch, an Application-Specific Integrated Circuit (ASIC), a programmable logic controller, or an embedded microprocessor. Examples of the controller include, but are not limited to, the following microprocessors: ARC 625D, AtmelAT91SAM, Microchip PIC18F26K20, and Silicone Labs C8051F320. The memory controller can also be implemented as a part of the control logic of the memory. Those skilled in the art also know that it is completely feasible to logically program the method steps to enable the controller to achieve the same functions in the form of logic gate, switch, application-specific integrated circuit, programmable logic controller and embedded microcontroller etc., in addition to implementing the controller by pure computer readable program codes. Therefore, the controller can be considered as a hardware component, and the apparatus for implementing various functions included therein can also be considered as a structure in the hardware component. Alternatively, the apparatus for implementing various functions can be considered as both a software module for implementing the method and a structure in the hardware component.

The system, apparatus, module, or unit described in the above embodiments can be specifically implemented by a computer chip or an entity, or a product with a certain function. A typical implementation device is a computer. To be specific, the computer for example may be a personal computer, a laptop computer, a cellular phone, a camera phone, a smartphone, a personal digital assistant, a media player, a navigation device, an email device, a game console, a tablet computer, or a wearable device, or combinations thereof.

For ease of description, the apparatus is described by various units divided by functions. Certainly, during implementation of the present disclosure, the functions of the respective units can be implemented in one or more pieces of software and/or hardware.

Those skilled in the art should understand that one or more embodiments of the present disclosure can be provided as a method, a system, or a computer program product. Therefore, the one or more embodiments of the present disclosure may be in the form of embodiments of hardware only, embodiments of software only and embodiments of combination of software and hardware. In addition, the one or more embodiments of the present disclosure may take the form of a computer program product that is implemented on one or more computer-usable storage medium (including but not limited to a disk memory, a CD-ROM, and an optical memory) containing computer-usable program codes.

The present disclosure is described with reference to the flowcharts and/or block diagrams of the method, the device (system), and the computer program product according to the embodiments of the present disclosure. It should be understood that each process and/or block in the flowchart and/or the block diagram and a combination thereof can be implemented by the computer program instructions. These computer program instructions can be provided for a general-purpose computer, a dedicated computer, an embedded processor, or a processor of any other programmable data processing device to generate a machine, such that the instructions executed by a computer or a processor of other programmable data processing devices generate an apparatus for implementing the function specified in one or more flows in the flowcharts or in one or more blocks in the block diagrams.

These computer program instructions also can be stored in a computer readable memory that can instruct the computer or other programmable data processing device to work in a specific method, such that the instructions stored in the computer readable memory generate an article that includes an instruction apparatus. The instruction apparatus implements the function specified in one or more flows in the flowcharts or in one or more blocks in the block diagrams.

These computer program instructions also can be loaded to a computer or another programmable data processing device, such that a series of operation steps are performed on the computer or the other programmable device to generate computer-implemented processing. Therefore, the instructions executed on the computer or the other programmable device provide steps for implementing the function specified in one or more flows in the flowcharts or in one or more blocks in the block diagrams.

It is to be noted that the term “include”, “contain”, or any other variants thereof is intended to be a non-exclusive inclusion, such that a process, a method, a product, or a device including a list of elements not only includes those elements but also contains other elements which are not explicitly listed, or elements inherent to such process, method, product, or device. Elements defined by the expression of “including one . . . ” do not, without more constraints, exclude the presence of additional identical elements in the process, method, product, or device including the elements.

One or more embodiments of the present disclosure can be described in the general context of the computer executable instructions executed by the computer, e.g., program module. Generally, the program module includes a routine, a program, an object, an assembly, a data structure for executing a specific task or implementing a specific abstract data type. One or more embodiments of the present disclosure can also be carried out in distributed computing environments. In the distributed computing environments, tasks are performed by remote processing devices connected through a communications network. In the distributed computing environments, the program module can be located in both local and remote computer storage media including storage devices.

The embodiments in the present disclosure are all described in a progressive way. The same or similar parts among the embodiments may refer to each other. Each embodiment focuses on its difference from the others. Particularly, a system implementation is basically similar to a method implementation, and therefore is described briefly. Related parts of the system embodiment may refer to description of the method embodiment.

The previous description is merely embodiments of the present disclosure and does not restrict the present disclosure. For those skilled in the art, the present disclosure may be modified or changed in various ways. Any modifications, equivalent substitutions and improvements shall fall within the scope of the claims of the present disclosure as long as they are within the spirit and the principle of the present disclosure.

I/We claim:

1. A method for audio processing, comprising:
obtaining first music data and a processing instruction in text form associated with the first music data;
extracting, by a music processing model, a first chord progression feature and an audio feature of the first music data, and a text feature of the processing instruction; and
processing, by the music processing model, the audio feature in accordance with the first chord progression feature and the text feature, to generate second music data; wherein a similarity between a first chord progression feature of the first music data and a second chord progression feature of the second music data is greater than a similarity threshold.

2. The method of claim 1, wherein processing, by the music processing model, the audio feature in accordance with the first chord progression feature and the text feature, to generate second music data includes:
performing, by the music processing model, feature compression processing on the audio feature and a noise feature of random noise data in accordance with the text feature to obtain a first feature; wherein the first feature represents information associated with the processing instruction in the first music data and information associated with the processing instruction in the random noise data; the random noise data are noise data randomly generated for the first music data by the music processing model; and
performing, by the music processing model, feature weight adjustment processing and feature restoration processing on the first feature in accordance with the first chord progression feature and the text feature, to generate second music data; wherein feature values in the first feature have feature weights, the feature weights are configured to indicate importance of the feature values at feature restoration, and the feature weight adjustment processing is configured to adjust the feature weights.

3. The method of claim 2, wherein performing, by the music processing model, the feature compression processing on the audio feature and the noise feature of the random noise data in accordance with the text feature to obtain the first feature includes:
down-sampling the audio feature by the music processing model, and down-sampling the noise feature and the down-sampled audio feature in accordance with the text feature to obtain the first feature.

4. The method of claim 3, wherein the music processing model includes a first down-sampling unit and a second down-sampling unit; the first down-sampling unit includes a plurality of first down-sampling layers connected sequentially; and the second down-sampling unit includes a plurality of second down-sampling layers connected sequentially; wherein down-sampling the audio feature by the music processing model, and down-sampling the noise feature and the down-sampled audio feature in accordance with the text feature to obtain the first feature includes:
down-sampling the audio feature by respective first down-sampling layers; wherein an input of a first layer of first down-sampling layers includes the audio feature; an input of an n+1-th layer of first down-sampling layers includes an output of an n-th layer of first down-sampling layers; the n is greater than or equal to 1, and is smaller than or equal to an integer of T−1, wherein T is a number of first down-sampling layers;
down-sampling, by respective second down-sampling layers, the noise feature and the down-sampled audio feature in accordance with the text feature; wherein an input of a first layer of second down-sampling layers includes the noise feature, an output of a first layer of first down-sampling layers and the text feature; an input of an m+1-th layer of second down-sampling layers includes an output of an m-th layer of first down-sampling layers, an output of an n+1-th layer of first down-sampling layers and the text feature; the m is greater than or equal to 1, and is smaller than or equal to an integer of S−1, wherein S is a number of second down-sampling layers; and a feature output by a last layer of second down-sampling layers is the first feature.

5. The method of claim 2, wherein the music processing module includes a feature weight adjustment unit and a feature restoration unit; performing, by the music processing model, the feature weight adjustment processing and the feature restoration processing on the first feature in accordance with the first chord progression feature and the text feature, to generate the second music data includes:
adjusting, by the feature weight adjustment unit, feature weights of respective feature values in the first feature in accordance with the first chord progression feature, to obtain the first feature after feature weight adjustment;
performing, by the feature restoration unit, feature restoration on the first feature after feature weight adjustment in accordance with the text feature, to generate second music data.

6. The method of claim 5, wherein the feature weight adjustment unit includes a feature weight adjustment layer based on attention mechanism; adjusting, by the feature weight adjustment unit, the feature weights of respective feature values in the first feature in accordance with the first chord progression feature, to obtain the first feature after feature weight adjustment includes:
adjusting, by the feature weight adjustment layer, feature weights of respective feature values in the first feature based on attention mechanism in accordance with the first chord progression feature, to obtain the first feature after feature weight adjustment.

7. The method of claim 5, wherein the feature restoration unit includes a plurality of up-sampling layers connected sequentially; performing, by the feature restoration unit, the feature restoration on the first feature after feature weight adjustment in accordance with the text feature, to generate the second music data includes:
up-sampling, by respective up-sampling layers, the first feature after feature weight adjustment in accordance with the text feature; wherein an input of a first layer of up-sampling layers includes the first feature after feature weight adjustment and the text feature; an input of a p+1-th layer of up-sampling layers includes an output of a p-th layer of up-sampling layers and the text feature; the p is greater than or equal to 1, and is smaller than or equal to an integer of W−1, where the W is a number of up-sampling layers; and
decoding a feature output by a last layer of up-sampling layers to obtain the second music data.

8. The method of claim 7, wherein the music processing model includes an emotion style guide unit and a decoding unit; decoding the feature output by the last layer of up-sampling layers to obtain the second music data includes:
identifying, by the emotion style guide module, a music emotion and/or music style indicated by the text feature as decoding instruction information;
instructing, by the emotion style guide module, the decoding unit to decode a feature output by a last layer of up-sampling layers in accordance with the decoding instruction information, to obtain the second music data matching the decoding instruction information.

9. The method of claim 1, wherein the method also comprises:
obtaining sample music data, a sample processing instruction in text form associated with the sample music data and target music data corresponding to the sample music data;
extracting, by a pre-built neural network structure, a sample chord progression feature and a sample audio feature of the sample music data, and a sample text feature of the sample processing instruction; and
training the neural network structure based on the sample chord progression feature, the sample audio feature, the sample text feature and the target music data, where the trained neural network structure is the music processing model.

10. The method of claim 9, wherein training the neural network structure based on the sample chord progression feature, the sample audio feature, the sample text feature and the target music data includes:
superimposing, by the neural network structure, sample random noise data on the target music data to obtain target noise data;
extracting, by the neural network structure, a target noise feature of the target noise data; and
training the neural network structure based on the sample chord progression feature, the sample audio feature, the sample text feature and the target noise feature.

11. The method of claim 10, wherein training the neural network structure based on the sample chord progression feature, the sample audio feature, the sample text feature and the target noise feature includes:
performing, by the neural network structure, feature compression processing on the sample audio feature and the target noise feature in accordance with the sample text feature to obtain a second feature; wherein the second feature represents information associated with the sample processing instruction in the sample music data and information associated with the sample processing instruction in the target noise data;
performing, by the neural network structure, feature weight adjustment processing and feature restoration processing on the second feature in accordance with the sample chord progression feature and the sample text feature, to generate processed sample data music;
wherein feature values in the second feature have feature weights, the feature weights are configured to indicate importance of the feature values at feature restoration; and the feature weight adjustment processing is configured to adjust the feature weights; and
training the neural network structure based on the processed sample music data and the target music data.

12. The method of claim 11, wherein performing, by the neural network structure, the feature compression processing on the sample audio feature and the target noise feature in accordance with the sample text feature to obtain the second feature includes:
down-sampling, by the neural network structure, the sample audio feature, and down-sampling the target noise feature and the down-sampled sample audio feature in accordance with the sample text feature, to obtain the second feature.

13. The method of claim 12, wherein the neural network structure includes a first down-sampling unit and a second down-sampling unit; the first down-sampling unit includes a plurality of first down-sampling layers connected sequentially; and the second down-sampling unit includes a plurality of second down-sampling layers connected sequentially; wherein down-sampling the sample audio feature by the neural network structure, and down-sampling the target noise feature and the down-sampled sample audio feature in accordance with the sample text feature to obtain the second feature includes:
down-sampling the sample audio feature by respective first down-sampling layers; wherein an input of a first layer of first down-sampling layers includes the sample audio feature; an input of an n+1-th layer of first down-sampling layers includes an output of an n-th layer of first down-sampling layers; the n is greater than or equal to 1, and is smaller than or equal to an integer of T−1, wherein the T is a number of first down-sampling layers;
down-sampling, by respective second down-sampling layers, the target noise feature and the down-sampled sample audio feature in accordance with the sample text feature; wherein an input of a first layer of second down-sampling layers includes the target noise feature, an output of a first layer of first down-sampling layers and the sample text feature; an input of an m+1-th layer of second down-sampling layers includes an output of an m-th layer of first down-sampling layers, an output of an n+1-th layer of first down-sampling layers and the sample text feature; the m is greater than or equal to 1, and is smaller than or equal to an integer of S−1, wherein the S is a number of second down-sampling layers; a feature output by a last layer of second down-sampling layers is the second feature.

14. The method of claim 11, wherein the neural network structure includes a feature weight adjustment unit and a feature restoration unit; performing, by the neural network structure, the feature weight adjustment processing and the feature restoration processing on the second feature in accordance with the sample chord progression feature and the sample text feature, to generate the processed sample data music includes:
adjusting, by the feature weight adjustment unit, feature weights of respective feature values in the second feature in accordance with the sample chord progression feature, to obtain the second feature after feature weight adjustment;
performing, by the feature restoration unit, feature restoration on the second feature after feature weight adjustment in accordance with the sample text feature, to generate the processed sample music data.

15. The method of claim 14, wherein the feature weight adjustment unit includes a feature weight adjustment layer based on attention mechanism; adjusting, by the feature weight adjustment unit, the feature weights of respective feature values in the second feature in accordance with the sample chord progression feature, to obtain the second feature after feature weight adjustment includes:
adjusting, by the feature weight adjustment layer, feature weights of respective feature values in the second feature based on attention mechanism in accordance with the sample chord progression feature, to obtain the second feature after feature weight adjustment.

16. The method of claim 14, wherein the feature restoration unit includes a plurality of up-sampling layers connected sequentially; performing, by the feature restoration unit, the feature restoration on the second feature after feature weight adjustment in accordance with the sample text feature, to obtain the processed sample music data includes:
up-sampling, by respective up-sampling layers, the second feature after feature weight adjustment in accordance with the sample text feature; wherein an input of a first layer of up-sampling layers includes the second feature after feature weight adjustment and the sample text feature; an input of a p+1-th layer of up-sampling layers includes an output of a p-th layer of up-sampling layers and the sample text feature; the p is greater than or equal to 1, and is smaller than or equal to an integer of W−1, wherein the W is a number of up-sampling layers;
decoding a feature output by a last layer of up-sampling layers to obtain the processed sample music data.

17. An electronic device, comprising:
a processor; and
a memory configured to store computer-executable instructions, the computer-executable instructions, when executed, causing the processor to:
obtain first music data and a processing instruction in text form associated with the first music data;
extract, by a music processing model, a first chord progression feature and an audio feature of the first music data, and a text feature of the processing instruction; and
process, by the music processing model, the audio feature in accordance with the first chord progression feature and the text feature, to generate second music data; wherein a similarity between a first chord progression feature of the first music data and a second chord progression feature of the second music data is greater than a similarity threshold.

18. The electronic device of claim 17, wherein the music processing model is caused to process the audio feature in accordance with the first chord progression feature and the text feature, to generate second music data by:
performing, by the music processing model, feature compression processing on the audio feature and a noise feature of random noise data in accordance with the text feature to obtain a first feature; wherein the first feature represents information associated with the processing instruction in the first music data and information associated with the processing instruction in the random noise data; the random noise data are noise data randomly generated for the first music data by the music processing model; and
performing, by the music processing model, feature weight adjustment processing and feature restoration processing on the first feature in accordance with the first chord progression feature and the text feature, to generate second music data; wherein feature values in the first feature have feature weights, the feature weights are configured to indicate importance of the feature values at feature restoration, and the feature weight adjustment processing is configured to adjust the feature weights.

19. The electronic device of claim 18, wherein the music processing model is caused to perform the feature compression processing on the audio feature and the noise feature of the random noise data in accordance with the text feature to obtain the first feature by:
down-sampling the audio feature by the music processing model, and down-sampling the noise feature and the down-sampled audio feature in accordance with the text feature to obtain the first feature.

20. A computer readable storage medium, wherein the computer readable stored medium stores computer-executable instructions, the computer-executable instructions, when executed by a processor, causing the processor to:
obtain first music data and a processing instruction in text form associated with the first music data;
extract, by a music processing model, a first chord progression feature and an audio feature of the first music data, and a text feature of the processing instruction; and
process, by the music processing model, the audio feature in accordance with the first chord progression feature and the text feature, to generate second music data; wherein a similarity between a first chord progression feature of the first music data and a second chord progression feature of the second music data is greater than a similarity threshold.
